(19) United States
(12) Patent Application Publication
(10) Pub. No.: US 2026/0044293 A1
(43) Pub. Date: Feb. 12, 2026

(54) IMAGE-FORMING APPARATUS AUTOMATICALLY TURNING OFF POWER TO HARDWARE THEREIN

(71) Applicant: BROTHER KOGYO KABUSHIKI KAISHA, Nagoya (JP)

(72) Inventor: Yusuke MIZUNO, Nagoya (JP)

(73) Assignee: BROTHER KOGYO KABUSHIKI KAISHA, Nagoya (JP)

(21) Appl. No.: 19/264,554

(22) Filed: Jul. 9, 2025

(30) Foreign Application Priority Data
Aug. 9, 2024 (JP) 2024-134345

(51) Int. Cl. G06F 3/12; G03G 15/00; G03G 15/20

(52) U.S. Cl. CPC G06F 3/1221; G03G 15/2017; G03G 15/205; G03G 15/5004; G03G 15/5016; G03G 15/5075; G06F 3/1229; G06F 3/1267

(57) ABSTRACT

An image-forming apparatus includes: a fuser; a memory; and a controller. The controller is configured to perform: an auto power-off process when an auto power-off time period is stored in the memory; and a scheduled power-off process when a power-off schedule is stored in the memory. The auto power-off process includes: turning off, when a predetermined condition is met and the auto-power-off time period has elapsed after the image-forming apparatus transitions to a predetermined state, power to first hardware including the controller and the memory. The predetermined state is a state where power to second hardware other than the controller and the memory is off and power to the fuser is off. The scheduled power-off process includes: turning off, when the predetermined condition is met and a time point included in the power-off schedule has passed while the image-forming apparatus is in the predetermined state, power to the first hardware.

### REFERENCE TO RELATED APPLICATIONS

This application claims priority from Japanese Patent Application No. 2024-134345 filed on Aug. 9, 2024. The entire content of the priority application is incorporated herein by reference.

### BACKGROUND ART

An image-forming apparatus is known that can switch to a sleep state when the image-forming apparatus has remained in a non-use state in which the image-forming apparatus is not in use for a predetermined period of time (time period).

### SUMMARY

However, the above-described image-forming apparatus does not support switching to a state in which the image-forming apparatus consumes less power than in the sleep state.

In view of the foregoing, it is an object of the present disclosure to provide an image-forming apparatus capable of transitioning to a state in which the image-forming apparatus consumes less power than in the sleep state according to a method specified in advance by the user.

In order to attain the above and other objects, according to one aspect, the present disclosure provides an image-forming apparatus. The image-forming apparatus includes: a printing engine; a fuser; a memory; and a controller. The controller is configured to perform: storing, in response to receiving an input specifying an auto power-off time period, the auto power-off time period in the memory. The controller is configured to perform: storing, in response to receiving an input specifying a power-off schedule including a time point, the power-off schedule in the memory. The controller is configured to further perform: an auto power-off process when the auto power-off time period is stored in the memory. The auto power-off process includes: turning off, when a predetermined condition is met and the auto power-off time period has elapsed after the image-forming apparatus transitions to a predetermined state, power to first hardware in the image-forming apparatus. The first hardware is hardware including the controller and the memory. The predetermined state is a state where power to second hardware in the image-forming apparatus is off and power to the fuser is off. The second hardware is predetermined hardware other than the controller and the memory. The controller is configured to further perform: a scheduled power-off process when the power-off schedule is stored in the memory. The scheduled power-off process includes: turning off, when the predetermined condition is met and the time point included in the power-off schedule has passed while the image-forming apparatus is in the predetermined state, the power to the first hardware.

The image-forming apparatus having the configuration described above can execute a process for transitioning to a state in which the image-forming apparatus consumes less power than in a sleep state.

### BRIEF DESCRIPTION OF DRAWINGS

FIG. 1 is a block diagram illustrating the electrical configuration of a multifunction peripheral (abbreviated as “MFP”).

FIG. 2 is a cross-sectional view illustrating the internal structure of the MFP.

FIG. 3A illustrates an example of an Ecology settings screen.

FIG. 3B illustrates an example of a Scheduled Power-Off settings screen.

FIG. 3C illustrates an example of a Scheduled Power-Off Days settings screen.

FIG. 3D illustrates an example of a Custom Schedule settings screen.

FIG. 3E illustrates another example of the Scheduled Power-Off settings screen.

FIG. 4A illustrates still another example of the Scheduled Power-Off settings screen.

FIG. 4B illustrates an example of a Scheduled Power-Off Time settings screen.

FIG. 4C illustrates still another example of the Scheduled Power-Off settings screen.

FIG. 4D illustrates another example of the Ecology settings screen.

FIG. 5 is a diagram illustrating an example of setting items that are configurable in settings information stored in a memory and possible setting values of each setting item.

FIG. 6 is a diagram illustrating an example of state transitions of the MFP.

FIG. 7 is a flowchart illustrating steps in a power-off state transition determination process.

FIG. 8 is a flowchart illustrating steps in a power-off availability determination process.

FIG. 9 is a flowchart illustrating steps in a power-off execution determination process.

FIG. 10 is a flowchart illustrating steps in a scheduled power-on function setting process.

FIG. 11 is a flowchart illustrating steps in a warming-up state transition determination process.

FIG. 12 is a flowchart illustrating steps in a modification of the power-off state transition determination process illustrated in FIG. 7.

### DESCRIPTION

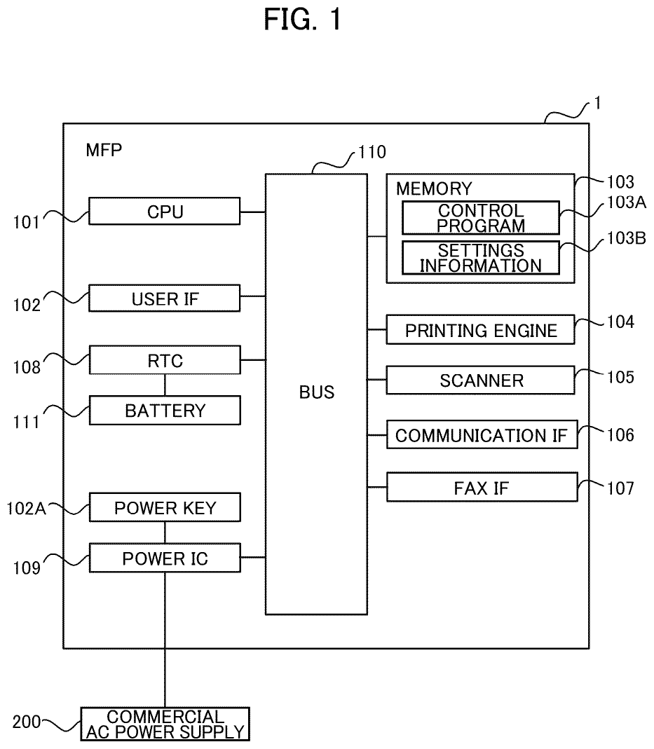

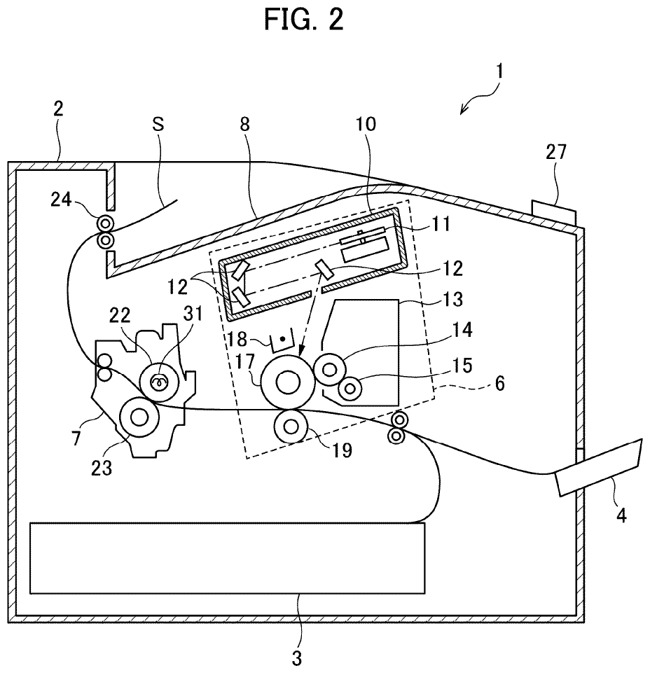

Below, an image-forming apparatus according to an embodiment of the present disclosure will be described using the example of an MFP 1. The MFP 1 illustrated in FIGS. 1 and 2 includes a CPU 101, a user interface 102, a memory 103, a printing engine 104, a scanner 105, a communication interface 106, a fax interface 107, an RTC 108, and a power IC 109, all of which are electrically interconnected via a bus 110. In the drawings, interface is abbreviated as “IF”. “RTC” is an abbreviation of “real-time clock.” “IC” is an abbreviation of “integrated circuit.” The MFP is an example of the image-forming apparatus of the present disclosure. The CPU 101 is an example of the controller of the present disclosure.

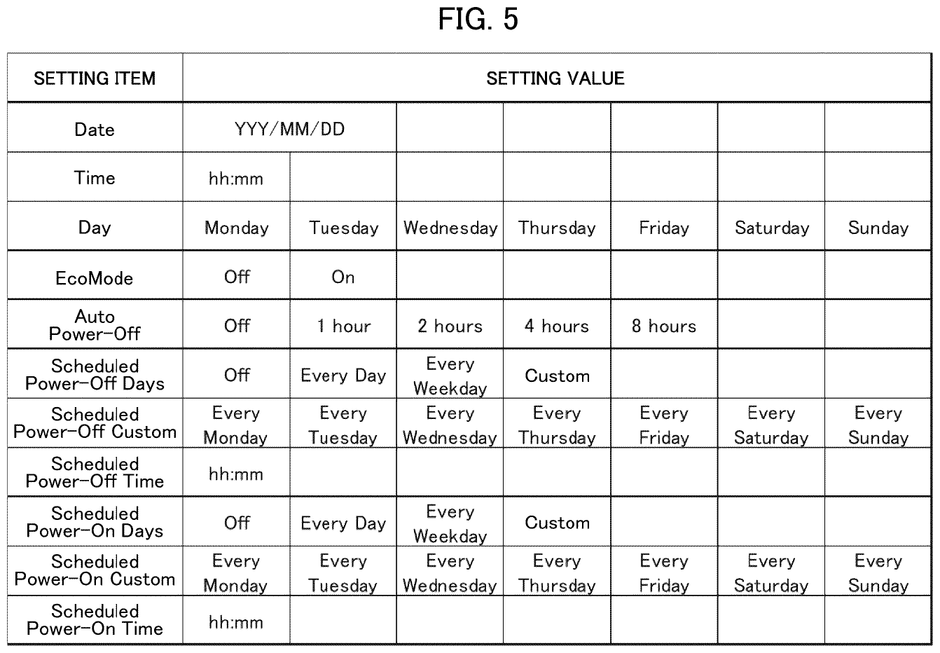

The CPU 101 executes various processes according to a control program 103A read from the memory 103 or based on user operations. The MFP 1 may include, as the CPU 101, a single piece of hardware or multiple pieces of hardware provided for individual functions. The memory 103 stores various programs and data, including the control program 103A and settings information 103B. The control program 103A causes the MFP 1 to perform various operations. These programs and data will be described later in detail with reference to FIGS. 5 through 12. The memory 103 is also used as a work area when the CPU 101 executes various processes. A buffer provided in the CPU 101 is also an example of the memory. The settings information 103B includes information stored in volatile memory such as RAM and information stored in nonvolatile memory such as NVRAM.

Examples of the memory 103 may include, for example, ROM, RAM, NVRAM, and a hard disk drive built into the MFP 1, or may include a storage medium that is readable and writable by the CPU 101. External memory such as USB memory or a hard disk drive connected to the MFP 1 via the communication interface 106 or memory or a hard disk drive provided in a device connected to the MFP 1 via the communication interface 106 are all examples of the memory 103. A computer-readable storage medium is a non-transitory medium. In addition to the above examples, non-transitory media include storage media such as CD-ROM and DVD-ROM. A non-transitory medium is also a tangible medium. On the other hand, electric signals that convey programs downloaded from, for example, a server on the Internet are a computer-readable signal medium, which is one type of computer-readable medium but is not included in a non-transitory computer-readable storage medium. The memory 103 is an example of the memory of the present disclosure.

The user interface 102 enables the user operating the MFP 1 to communicate with the CPU 101. The user interface 102 has a touchscreen and physical operating keys, for example. The user interface 102 is an example of the user interface of the present disclosure. The printing engine 104 includes configurations for printing images on sheets or other printing media according to the electrophotographic method. The printing engine 104 is an example of the printing engine of the present disclosure. The scanner 105 generates scan data (image data) by reading a document. The MFP 1 is also capable of executing compound operations that combine a plurality of operations, such as an operation to generate scan data and an operation to execute printing.

The communication interface 106 connects the MFP 1 to a network (not illustrated). The communication interface 106 is an example of the network interface of the present disclosure. The fax interface 107 can perform a fax reception process for receiving fax data (image data) via a telephone line (not illustrated) and controlling the printing engine 104 to execute printing based on the fax data, and a fax transmission process for transmitting scan data read by the scanner 105 to a predetermined address via a telephone line. The fax interface 107 is an example of the facsimile interface of the present disclosure.

The RTC 108 is a clock built into the MFP 1. A battery 111 continuously supplies electric power (voltage) to the RTC 108 so that the RTC 108 continues to keep time, even when the power supply to the MFP 1 is halted. The CPU 101 may be configured to set the current time in the RTC 108 based on a user instruction received through the user interface 102.

The power IC 109 is connected to a power key 102A and a commercial AC power supply 200. The power IC 109 functions to start and stop the supply of electric power from the commercial AC power supply 200 to various components in the MFP 1, such as the CPU 101 and memory 103, in response to an ON or OFF operation performed on and received through the power key 102A. The power IC 109 further includes an auto power-on function described later. Note that the power key 102A is a physical key. The power IC 109 is an example of the power integrated circuit of the present disclosure.

As illustrated in FIG. 2, the MFP 1 includes a main housing 2, a supply tray 3, a manual tray 4, a process unit 6, and a fuser 7. The supply tray 3 is disposed in the bottom section of the main housing 2 and accommodates sheets S therein. The manual feed tray 4 is provided for manually feeding sheets S into the main housing 2. The process unit 6 is disposed in the upper section of the main housing 2 and functions to form toner images on sheets S supplied from the supply tray 3 or manual feed tray 4. The process unit 6 corresponds to the printing engine 104 in FIG. 1. The fuser 7 is disposed downstream of the process unit 6 in a sheet-conveying direction and functions to perform a fixing process for heating sheets S on which the process unit 6 has formed toner images. Discharge rollers 24 are disposed downstream of the fuser 7 in the sheet-conveying direction. The MFP 1 uses the discharge rollers 24 to discharge sheets S into a discharge tray 8 formed on the top of the main housing 2.

The fuser 7 is an example of the fuser of the present disclosure. Note that the term “fuser” may be replaced with “fixing device” or “fixing unit”.

The process unit 6 includes a scanning unit 10, a developing cartridge 13, a photosensitive drum 17, a charger 18, and a transfer roller 19.

The scanning unit 10 is arranged in the upper section of the main housing 2. The scanning unit 10 includes a laser light-emitting unit (not illustrated), a polygon mirror 11, a plurality of reflecting mirrors 12, and a plurality of lenses (not illustrated). Within the scanning unit 10, a laser beam emitted from the laser light-emitting unit is irradiated in a high-speed scan onto the surface of the photosensitive drum 17 after reflecting off the polygon mirror 11 and reflecting mirrors 12 and passing through the lenses, as depicted by the one-dot chain line.

The developing cartridge 13 is detachably mounted in the main housing 2. The developing cartridge 13 has interior space for accommodating toner therein, and a toner supply opening through which toner is supplied to the photosensitive drum 17. A developing roller 14 and a supply roller 15 are arranged to face each other at the toner supply opening. Toner in the developing cartridge 13 is supplied to the developing roller 14 by the rotation of the supply roller 15 and carried on the surface of the developing roller 14.

The charger 18 is disposed above the photosensitive drum 17 with a gap therebetween. The transfer roller 19 is disposed below the photosensitive drum 17 and faces the photosensitive drum 17. While the photosensitive drum 17 rotates, the charger 18 applies a uniform charge to the surface of the photosensitive drum 17 with positive polarity, for example. Subsequently, the laser beam emitted from the scanning unit 10 forms an electrostatic latent image on the surface of the photosensitive drum 17.

As the photosensitive drum 17 continues to rotate while in contact with the developing roller 14, toner carried on the surface of the developing roller 14 is supplied to the electrostatic latent image on the surface of the photosensitive drum 17, forming a toner image.

The toner image is subsequently transferred onto a sheet S by a transfer bias applied by the transfer roller 19 as the sheet S passes between the photosensitive drum 17 and transfer roller 19.

The fuser 7 is arranged downstream of the process unit 6 in the sheet-conveying direction. The fuser 7 includes a fixing roller 22, a pressure roller 23 pressed against the fixing roller 22, and a heater 31 for heating the fixing roller 22. The MFP 1 further includes a display unit 27 for displaying printing information, for example. The display unit 27 is included in the user interface 102 in FIG. 1.

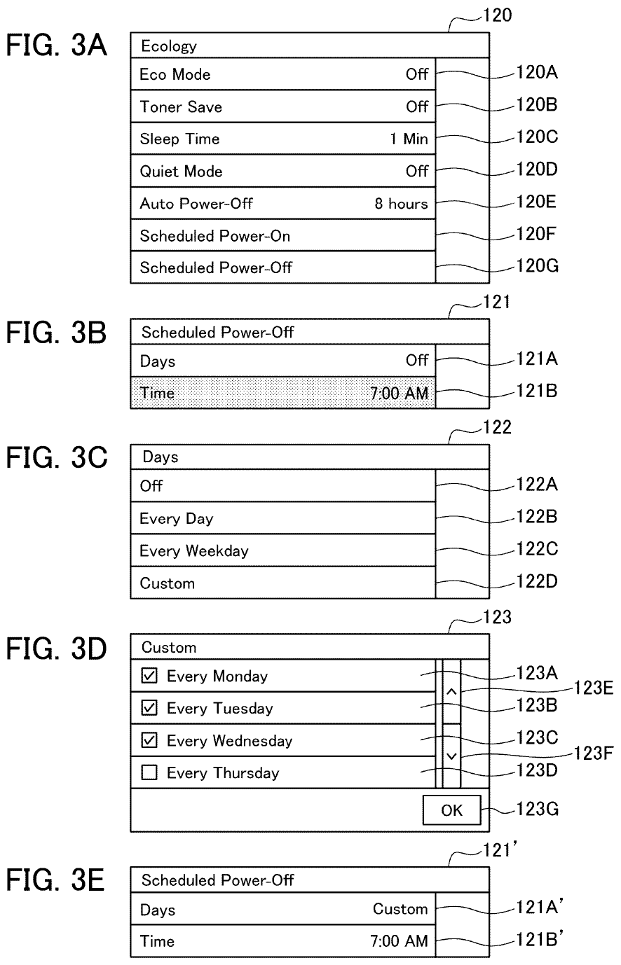

The MFP 1 allows various settings to be configured as ecology settings. FIG. 3A illustrates an Ecology settings screen 120 displayed on the user interface 102. The Ecology settings screen 120 includes an Eco Mode label 120A, a Toner Save label 120B, a Sleep Time label 120C, a Quiet Mode label 120D, an Auto Power-Off label 120E, a Scheduled Power-On label 120F, and a Scheduled Power-Off label 120G.

When the Eco Mode label 120A is operated, for example, the CPU 101 displays an Eco Mode setting screen (not illustrated) for configuring the eco mode setting. For example, the eco mode is configured by selecting one of Eco Mode On and Eco Mode Off in the Eco Mode setting screen. Similarly, when any of the Toner Save label 120B, Sleep Time label 120C, Quiet Mode label 120D, Auto Power-Off label 120E, Scheduled Power-On label 120F, and Scheduled Power-Off label 120G is operated, the CPU 101 displays a settings screen for the corresponding setting on the user interface 102. The user can then configure the corresponding setting by selecting a setting value in the displayed settings screen.

The eco mode is designed to make the MFP 1 operate in an environmentally friendly manner. For example, the eco mode saves toner consumption during printing by turning the Toner Save setting on and reduces power consumption by turning on the Quiet Mode setting to convey sheets S at a slower speed than a normal speed and by setting the fixing temperature of the fuser 7 lower than a normal fixing temperature. In other words, the conveying speed of the sheets S is set slower when the eco mode is enabled than when the eco mode is disabled, and the fixing temperature of the fuser 7 is set lower when the eco mode is enabled than when the eco mode is disabled. The eco mode also causes the MFP 1 to transition to a sleep state earlier than the point in time (time point) configured in the Sleep Time setting. Hence, when the user operates the Eco Mode label 120A to display the Eco Mode setting screen and selects Eco Mode On in the Eco Mode setting screen, the Toner Save setting and Quiet Mode setting are both turned on, i.e., both enabled. Of course, the eco mode may be configured to turn on only one of the Toner Save setting and Quiet Mode setting or to keep both settings off while causing the MFP 1 to transition to a sleep state after a shorter time period (e.g., ten seconds) than the time period set by the Sleep Time setting (one minute in the example of FIG. 3).

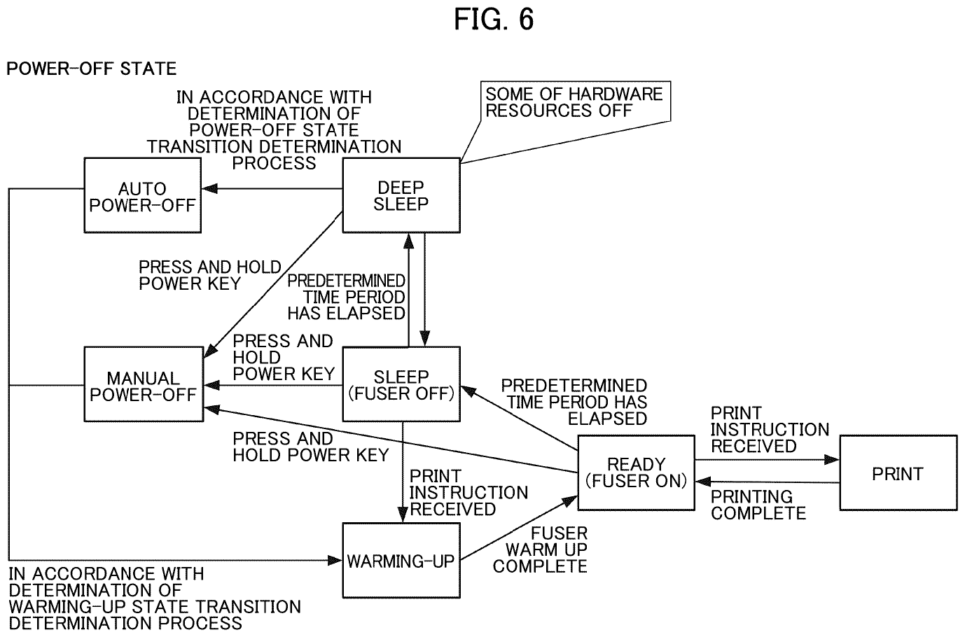

As illustrated in FIG. 6, the MFP 1 can transition to two power-off states in which the MFP 1 consumes less power than a deep sleep state: an auto power-off state; and a manual power-off state. When the MFP 1 automatically transitions to the power-off state through a scheduled power-off function or an auto power-off function described later, the power-off state of the MFP 1 is referred to as the auto power-off state. When the MFP 1 transitions to the power-off state in response to a user operation received through the power key 102A, for example, the power-off state of the MFP 1 is referred to as the manual power-off state. While the MFP 1 is in the deep sleep state, at least the power to the CPU 101 and memory 103 remains on. In contrast, while the MFP 1 is in the power-off state, the power to the CPU 101 and memory 103 is turned off, and only the power to the RTC 108 and power IC 109 remains on. Accordingly, the functions of the RTC 108, including a function to keep time, and the functions of the power IC 109, including a function to detect an operation on the power key 102A, are enabled.

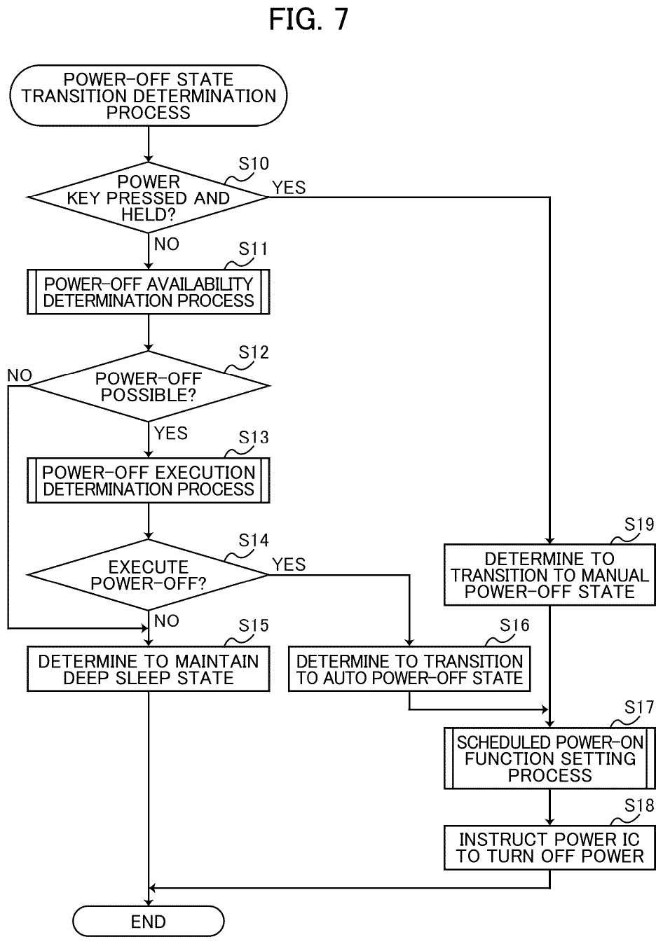

The MFP 1 transitions to the auto power-off state from the deep sleep state according to a determination in a power-off state transition determination process (described later with reference to FIG. 7), when either an enabled auto power-off setting or an enabled scheduled power-off setting has been configured, and the MFP 1 is in the deep sleep state. In other words, the MFP 1 can transition to the auto power-off state only when the MFP 1 is in the deep sleep state and after a plurality of other conditions have been met, even when an enabled auto power-off setting or an enabled scheduled power-off setting has been configured.

On the other hand, the MFP 1 can transition to the manual power-off state from a ready state, a sleep state, or a deep sleep state by the power key 102A being pressed and held. While the MFP 1 is in the ready state, at least the power to the fuser 7 is on, and the MFP 1 is capable of printing immediately upon receiving a print instruction. While the MFP 1 is in the sleep state, at least the power to the fuser 7 is off. While the MFP 1 is in the deep sleep state, power to additional components, such as the user interface 102, is off, in addition to the components already powered off in the sleep state. Components in which power is turned on or off include at least hardware components and therefore may be referred to as hardware resources. The MFP 1 transitions from the ready state to the sleep state when, for example, a predetermined time period has elapsed without having received any print instructions. The MFP 1 transitions from the deep sleep state to the sleep state when, for example, the MFP 1 receives data via the communication interface 106 or fax interface 107.

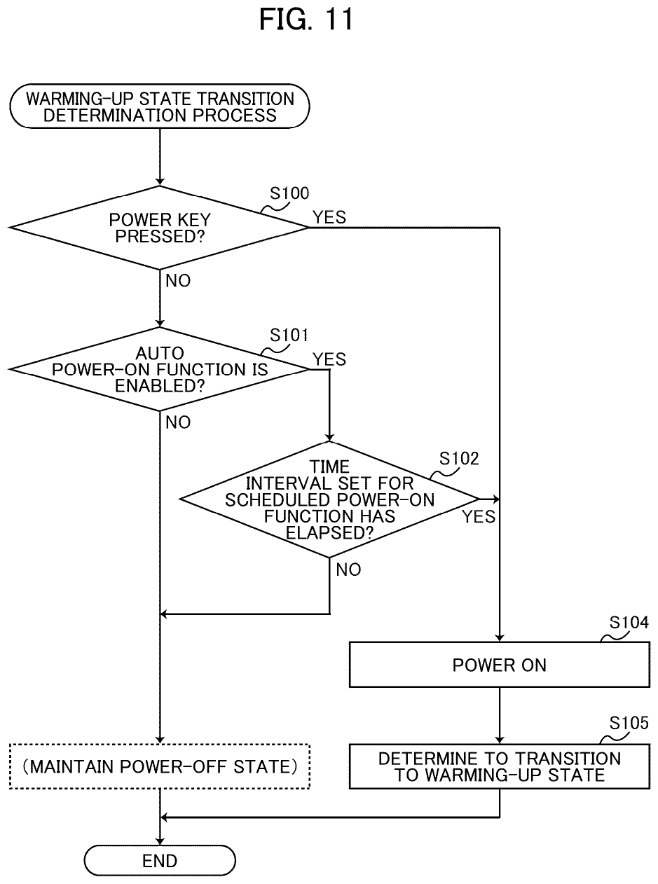

Furthermore, the MFP 1 transitions from the auto power-off state or the manual power-off state to a warming-up state in accordance with a determination made in a warming-up state transition determination process described later (see FIG. 11). The MFP 1 transitions from a warming-up state to the ready state when the fixing temperature of the fuser 7, to which power has been supplied, reaches a target temperature.

Returning to FIG. 3A, a settings screen for configuring settings related to the scheduled power-off function will be described. The scheduled power-off function will also be described later. When the Scheduled Power-Off label 120G is operated, the CPU 101 displays a Scheduled Power-Off settings screen 121 illustrated in FIG. 3B on the user interface 102. The MFP 1 uses the Scheduled Power-Off settings screen 121 to set a schedule for automatically transitioning from the deep sleep state to the auto power-off state. The Scheduled Power-Off settings screen 121 includes a Scheduled Power-Off Days label 121A, and a Scheduled Power-Off Time label 121B. Accordingly, the user can configure settings for setting items Scheduled Power-Off Days and Scheduled Power-Off Time in the Scheduled Power-Off settings screen 121.

FIG. 5 illustrates an example of the setting items that are configurable in the settings information 103B, as well as possible setting values of the setting items. The setting item Scheduled Power-Off Days can be set to one of four setting values: Off; Every Day; Every Weekday; and Custom. When the Scheduled Power-Off settings screen 121 of FIG. 3B is displayed, the setting item Scheduled Power-Off Days corresponding to the Scheduled Power-Off Days label 121A has been set to “Off.” In other words, no schedule has been set for automatically transitioning from the deep sleep state to the auto power-off state. Therefore, the setting item Scheduled Power-Off Time cannot be configured, and the Scheduled Power-Off Time label 121B is grayed out in the Scheduled Power-Off settings screen 121 so that the Scheduled Power-Off Time label 121B cannot be operated.

When the Scheduled Power-Off Days label 121A is operated in the Scheduled Power-Off settings screen 121, the CPU 101 displays a Scheduled Power-Off Days settings screen 122 illustrated in FIG. 3C on the user interface 102. The Scheduled Power-Off Days settings screen 122 includes labels 122A through 122D for selecting one of the four setting values “Off,” “Every Day,” “Every Weekday,” and “Custom.” When the user selects the Custom label 122D, for example, the CPU 101 displays a Custom Schedule settings screen 123 illustrated in FIG. 3D on the user interface 102. As illustrated in FIG. 5, the setting item Scheduled Power-Off Custom can be set to some or all of seven setting values representing each day of the week, i.e., from “Every Monday” to “Every Sunday.” Thus, the Custom Schedule settings screen 123 includes these seven setting values as selectable options. However, since the display area in the Custom Schedule settings screen 123 is not large enough to display all seven options from “Every Monday” to “Every Sunday,” labels 123A through 123D for selecting the four setting values “Every Monday” through “Every Thursday” are initially displayed in the Custom Schedule settings screen 123. Selectable labels for the other three setting values “Every Friday” through “Every Sunday” can be displayed in the display area by operating an Up icon 123E and a Down icon 123F. Labels for selecting each of the setting values “Every Monday” through “Every Sunday,” including the labels 123A through 123D, are toggled between being selected and being unselected each time the corresponding label is operated. When a label is selected, a checkmark is displayed in the checkbox within the corresponding label. When an OK icon 123G is subsequently operated, the CPU 101 stores the current settings in the memory 103 as the settings information 103B and switches the display on the user interface 102 from the Custom Schedule settings screen 123 to a Scheduled Power-Off settings screen 121′ illustrated in FIG. 3E.

The Scheduled Power-Off settings screen 121′ corresponds to the Scheduled Power-Off settings screen 121 of FIG. 3B. However, while the Scheduled Power-Off settings screen 121 displays “Off” in the Scheduled Power-Off Days label 121A, the Scheduled Power-Off settings screen 121′ displays “Custom” in the Scheduled Power-Off Days label 121A′. Furthermore, while the Scheduled Power-Off Time label 121B is grayed out in the Scheduled Power-Off settings screen 121, the Scheduled Power-Off Time label 121B′ is displayed normally in the Scheduled Power-Off settings screen 121′, enabling the user to select a time point for the setting item Scheduled Power-Off Time.

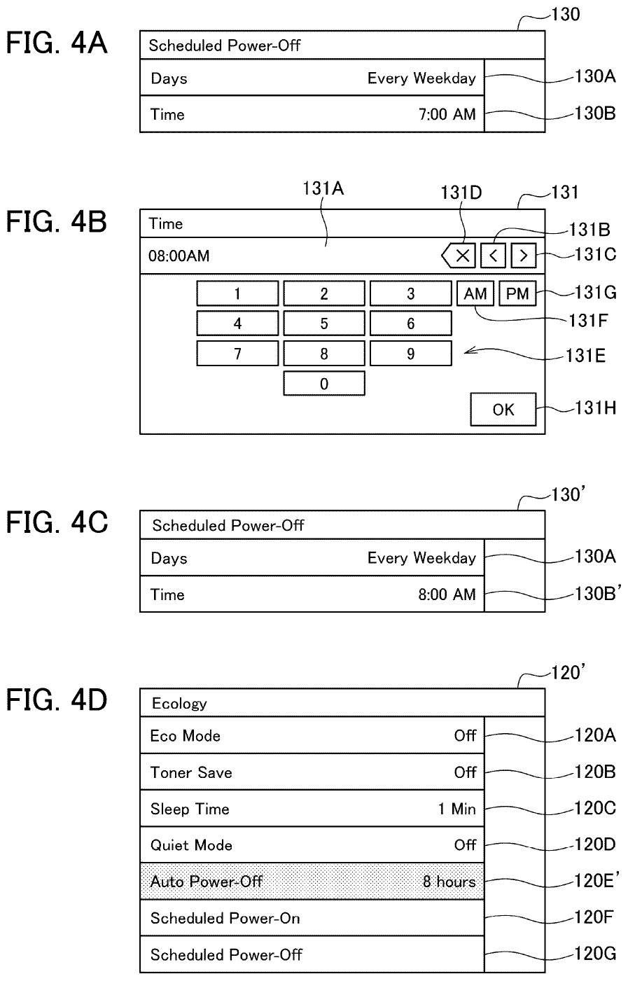

FIG. 4A illustrates a Scheduled Power-Off settings screen 130 when “Every Weekday” has been set as the setting value of the setting item Scheduled Power-Off Days. When the Scheduled Power-Off Time label 130B is operated in the Scheduled Power-Off settings screen 130, the CPU 101 displays a Scheduled Power-Off Time settings screen 131 illustrated in FIG. 4B on the user interface 102. The Scheduled Power-Off Time settings screen 131 includes a setting value display area 131A for displaying the setting value selected for the setting item Scheduled Power-Off Time, a Left icon 131B and a Right icon 131C for moving a cursor (not illustrated) in the left and right directions to indicate individual values within the setting values displayed in the setting value display area 131A, a deletion icon 131D for instructing deletion of the element at the cursor position, numeric keys 131E, and an AM icon 131F and a PM icon 131G for selecting “AM” and “PM”, respectively. By operating the icons 131B through 131G, including these numeric keys 131E, the user can change the setting value for the setting item Scheduled Power-Off Time. The Scheduled Power-Off Time settings screen 131 in FIG. 4B shows an example in which the setting value for the setting item Scheduled Power-Off Time has been changed from “7:00 AM” to “8:00 AM.” When an OK icon 131H is operated, the CPU 101 stores the time point currently displayed in the setting value display area 131A as the settings information 103B and switches the display on the user interface 102 from the Scheduled Power-Off Time settings screen 131 to a Scheduled Power-Off settings screen 130′ illustrated in FIG. 4C.

The Scheduled Power-Off settings screen 130′ corresponds to the Scheduled Power-Off settings screen 130 in FIG. 4A. While the Scheduled Power-Off Days label 130A is not different but displays “Every Weekday” in both the Scheduled Power-Off settings screen 130′ and the Scheduled Power-Off settings screen 130, the Scheduled Power-Off Time label 130B′ has changed from “7:00 AM,” which has been displayed in the Scheduled Power-Off Time label 130B, to “8:00 AM.”

Next, a settings screen for configuring settings related to a scheduled power-on function will be described. The scheduled power-on function will also be described later. When the Scheduled Power-On label 120F is operated in the Ecology settings screen 120 illustrated in FIG. 3A, the CPU 101 displays a Scheduled Power-On settings screen (not illustrated) on the user interface 102. In the Scheduled Power-On settings screen, the user sets a schedule for automatically transitioning from the power-off state to the warming-up state. As illustrated in FIG. 5, the scheduled power-on settings, like the scheduled power-off settings, include a setting item Scheduled Power-On Days, a setting item Scheduled Power-On Custom, and a setting item Scheduled Power-On Time. Possible setting values for each setting item of the scheduled power-on settings are no different from possible setting values for the scheduled power-off settings. Therefore, a settings screen for configuring the scheduled power-on settings can be prepared by changing the text “Scheduled Power-Off” displayed in the Scheduled Power-Off settings screen 121 to “Scheduled Power-On.” When transitioning from the Scheduled Power-On settings screen to one of a Scheduled Power-On Days settings screen, a Custom Schedule settings screen, and a Scheduled Power-On Time settings screen, screens similar to the corresponding Scheduled Power-Off Days settings screen 122, Custom Schedule settings screen 123, and Scheduled Power-Off Time settings screen 131 may be used. Therefore, drawings for the Scheduled Power-On settings screens and a detailed description of the method for configuring the scheduled power-on settings have been omitted.

Next, a setting screen will be described for configuring a setting related to the auto power-off function, which will be described later. When the Auto Power-Off label 120E is operated in the Ecology settings screen 120 illustrated in FIG. 3A, the CPU 101 displays an Auto Power-Off setting screen (not illustrated) on the user interface 102 for configuring the auto power-off setting. The Auto Power-Off setting screen is used to set the time period in which the MFP 1 remains in a deep sleep state before automatically transitioning to the auto power-off state. As illustrated in FIG. 5, the setting item Auto Power-Off has five possible setting values: Off; 1 Hour; 2 Hours; 4 Hours; and 8 Hours. The user can select one of these five setting values. Labels corresponding to each of the five setting values are displayed in the Auto Power-Off setting screen. The desired setting value for the setting item Auto Power-Off can be selected by operating the corresponding label.

The setting items Date, Time, and Day in FIG. 5 indicate the current date, time, and day. The CPU 101 sets the initial setting values for these setting items in accordance with user instructions received through the user interface 102. Thereafter, the current date and time are maintained by the RTC 108.

FIG. 4D illustrates the Ecology settings screen 120′ displayed after the scheduled power-off settings are enabled, i.e., after the setting item Scheduled Power-Off Days is set to a setting value other than “Off.” The Ecology settings screen 120′ corresponds to the Ecology settings screen 120 in FIG. 3A, except that the Auto Power-Off label 120E′ is grayed out in the Ecology settings screen 120′. This indicates that either the auto power-off setting or the scheduled power-off settings can be enabled, but both the auto power-off setting and the scheduled power-off settings cannot be enabled at the same time. In the example of FIG. 4D, the scheduled power-off settings have been enabled while the auto power-off setting is disabled. However, the present disclosure is not limited to this configuration. That is, it may be possible to enable both the auto power-off setting and the scheduled power-off settings at the same time, whereby the MFP 1 would perform operations according to each setting.

The CPU 101 stores values in the memory 103 specifying the settings for the scheduled power-off function in response to operations received through the Scheduled Power-Off settings screen. The CPU 101 also stores values in the memory 103 specifying settings for the scheduled power-on function in response to operations received through the Scheduled Power-On settings screen. The CPU 101 also stores a value in the memory 103 specifying the setting for the auto power-off function in response to operations received through the Auto Power-Off setting screen.

Next, the operations of the MFP 1 will be described with reference to flowcharts.

The following processes represent processes performed by the MFP 1 in accordance with instructions described in programs. In other words, processes in the following description using active verbs such as “determine,” “extract,” “select,” “calculate,” “set,” “identify,” “obtain,” “receive,” and “control” represent processes performed by the CPU 101. Processes performed by the CPU 101 include hardware control using an application programming interface (abbreviated as “API”) in an operating system (abbreviated as “OS”). However, this specification describes operations of each program while omitting the role of the OS. That is, a statement in the following description to the effect that “Program B controls Hardware C” may signify that “Program B controls Hardware C using the API of the OS.” Furthermore, a process performed by the CPU 101 according to an instruction described in a program may be described using an abbreviated expression, such as “the CPU 101 executes.”Note that the term “obtain” is used as a concept that does not necessarily require a request. In other words, a process by which the CPU 101 receives data without requesting that data is included in the concept of “the CPU obtains data.” Furthermore, the term “data” described herein is expressed in bit strings that can be read by a computer. Data of different formats are treated as the same data when the content of the data is essentially the same. The same holds true for “information” in this specification. Furthermore, the terms “requesting” and “instructing” are concepts that denote outputting information to another device indicating a request and an instruction, respectively. Furthermore, information indicating a request and information indicating an instruction will simply be described as a “request” and an “instruction,” respectively.

Furthermore, a process performed by the CPU 101 to determine whether Information A indicates Circumstance B may be conceptually described as “determining whether Circumstance B applies based on Information A.” Similarly, a process performed by the CPU 101 to determine whether Information A indicates Circumstance B or Circumstance C may be conceptually described as “determining whether Circumstance B or Circumstance C applies based on Information A.”

FIG. 7 is a flowchart illustrating steps in the power-off state transition determination process executed by the MFP 1, and particularly by the CPU 101. The power-off state transition determination process is started in response to the MFP 1 transitioning to a deep sleep state. Hereinafter, “step”in the descriptions of the following processes will be abbreviated as “S”.

In S10 of FIG. 7, the CPU 101 determines whether the power key 102A has been pressed and held. When the CPU 101 determines that the power key 102A has not been pressed and held (S10: NO), in S11 the CPU 101 executes a process to determine the availability of auto power-off or scheduled power-off (power-off availability determination process).

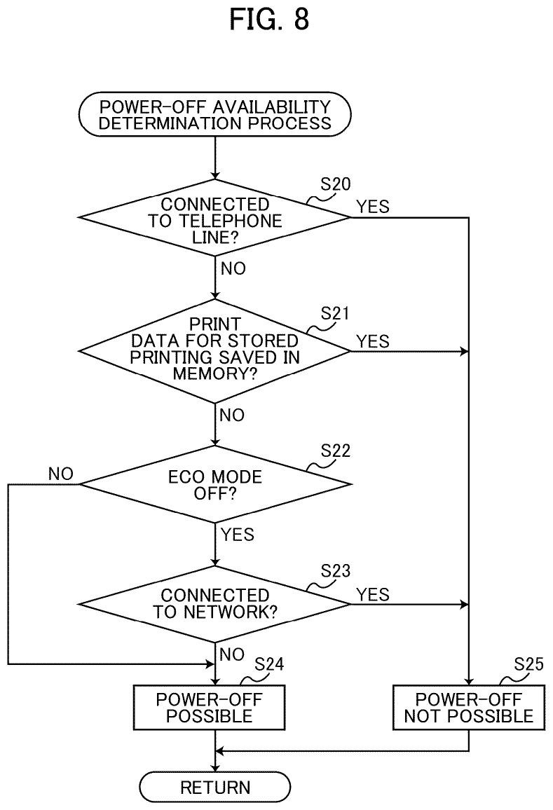

FIG. 8 illustrates steps in the power-off availability determination process. In S20 of FIG. 8, the CPU 101 determines whether the MFP 1 is connected to a telephone line via the fax interface 107. When the CPU 101 determines that the MFP 1 is not connected to a telephone line (S20: NO), in S21 the CPU 101 determines whether print data targeted for stored printing is saved in the memory 103. Stored printing is a method of storing print data in the memory 103, reading that print data later, and executing printing based on the read print data. When the CPU 101 determines that no print data targeted for stored printing is saved in the memory 103 (S21: NO), in S22 the CPU 101 determines whether the eco mode is “Off.” Since the setting value of the setting item Eco Mode indicating whether the eco mode is “On” or “Off” is stored in the memory 103 as the settings information 103B, as illustrated in FIG. 5, in S22 the CPU 101 reads the setting value of the setting item Eco Mode from the memory 103 and makes the determination based on this setting value.

When the CPU 101 determines in S22 that the eco mode is “Off” (S22: YES), in S23 the CPU 101 determines whether the MFP 1 is connected to a network via the communication interface 106. When the CPU 101 determines that the MFP 1 is not connected to a network (S23: NO), in S24 the CPU 101 determines that power-off is possible and subsequently ends the power-off availability determination process. However, when the CPU 101 determines in S23 that the MFP 1 is connected to a network (S23: YES), in S25 the CPU 101 determines that power-off is not possible and subsequently ends the power-off availability determination process.

However, when the CPU 101 determines in S22 that the eco mode is “On” (S22: NO), the CPU 101 does not perform the determination in S23 but advances directly to S24 and determines that power-off is possible. Subsequently, the CPU 101 ends the power-off availability determination process. When the eco mode is “On,” i.e., the eco mode is enabled, the CPU 101 determines that power-off is possible, regardless of whether the MFP 1 is connected to a network, because the goal of the eco mode is to reduce overall power consumption in the MFP 1 as much as possible. Thus, the conditions for determining whether power-off is possible are fewer when the eco mode is “On” than when the eco mode is “Off.” Specifically, when the eco mode is “Off,” the CPU 101 determines that power-off is possible when the following three conditions are met: the MFP 1 is not connected to a telephone line (S20: NO); print data targeted for stored printing is not saved in the memory 103 (S21: NO); and the MFP 1 is not connected to a network (S23: NO). When the eco mode is “On,” on the other hand, the CPU 101 determines that power-off is possible when two of the three conditions are met, excluding the condition that the MFP 1 is not connected to a network (S23: NO). The above conditions are merely examples, and the present disclosure is not limited to these. Furthermore, the conditions to be excluded when the eco mode is “On” are not limited to the single condition in the above example but may be two or more conditions.

On the other hand, when the CPU 101 determines in S20 that the MFP 1 is connected to a telephone line (S20: YES) or when the CPU 101 determines in S21 that print data targeted for stored printing is saved in the memory 103 (S21: YES), in S25 the CPU 101 determines that power-off is not possible and subsequently ends the power-off availability determination process. The CPU 101 determines that power-off is not possible when the MFP 1 is connected to a telephone line because the MFP 1 could be exchanging data with an external device via the fax interface 107. The CPU 101 also determines that power-off is not possible when print data targeted for stored printing is saved in the memory 103 so that the user can immediately perform stored printing with the MFP 1 at any time.

Returning to FIG. 7, in S12 the CPU 101 determines whether power-off is possible. Since power-off has been determined to be either possible or not possible in the power-off availability determination process of S11, the CPU 101 can make the determination in S12 according to the determination in S11. When the CPU 101 determines in S12 that power-off is not possible (S12: NO), the CPU 101 advances to S15. When the CPU 101 determines in S12 that power-off is possible (S12: YES), in S13 the CPU 101 performs a process to determine whether to execute or not the auto power-off or scheduled power-off (power-off execution determination process).

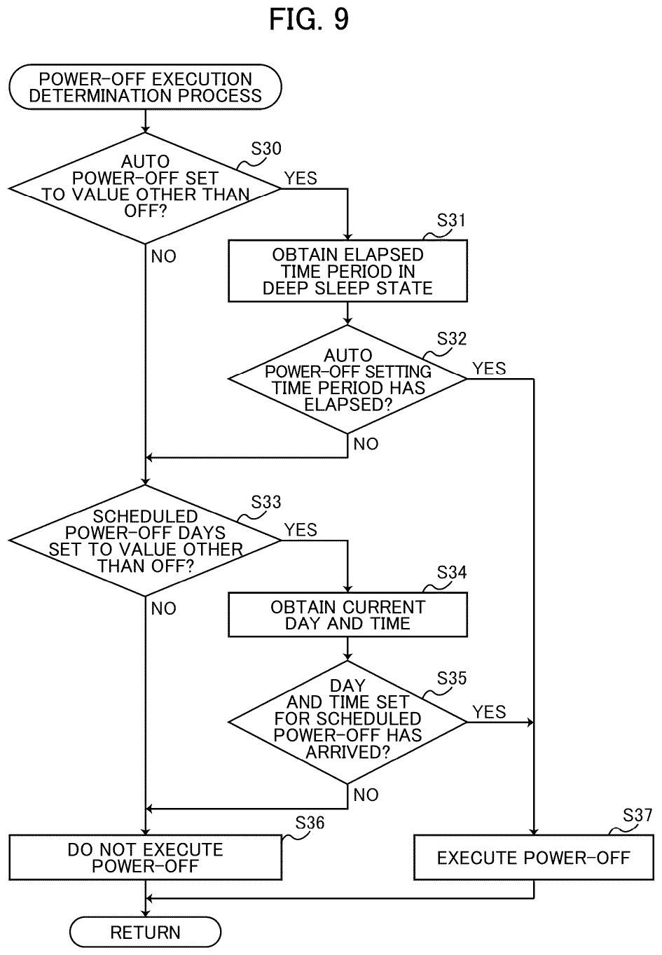

FIG. 9 illustrates steps in the power-off execution determination process. First, the CPU 101 begins a determination process for the auto power-off function. Specifically, in S30 the CPU 101 determines whether the setting item Auto Power-Off is set to a setting value other than “Off.” As described above with reference to FIG. 5, the setting item Auto Power-Off can be set to one of five setting values: Off; 1 Hour; 2 Hours; 4 Hours; and 8 Hours. Therefore, in S30 the CPU 101 determines whether the setting item Auto Power-Off is set to one of the setting values “1 Hour,” “2 Hours,” “4 Hours,” and “8 Hours.”

When the CPU 101 determines that the setting item Auto Power-Off is set to a setting value other than “Off” (S30: YES), in S31 the CPU 101 obtains the elapsed time period since the MFP 1 has transitioned to the deep sleep state. The MFP 1 maintains the time period elapsed since the MFP 1 has transitioned to the deep sleep state, and the CPU 101 obtains this elapsed time period. In S32 the CPU 101 determines whether the time period specified by the setting value of the setting item Auto Power-Off has elapsed based on the obtained elapsed time period. When the CPU 101 determines that the obtained elapsed time period is greater (longer) than or equal to the time period specified by the setting value of the setting item Auto Power-Off (S32: YES), in S37 the CPU 101 determines that power-off is to be executed, that is, the MFP 1 is to be powered off, and subsequently ends the power-off execution determination process. However, when the CPU 101 determines in S32 that the obtained elapsed time period is smaller (shorter) than the time period specified by the setting value of the setting item Auto Power-Off (S32: NO), the CPU 101 advances to S33.

On the other hand, when the CPU 101 determines in S30 that the setting value of the setting item Auto Power-Off is “Off” (S30: NO), the CPU 101 subsequently begins a determination process for the scheduled power-off function. Specifically, the CPU 101 advances to S33. In S33 the CPU 101 determines whether the setting item Scheduled Power-Off Days is set to a setting value other than “Off.” As described above with reference to FIG. 5, the setting item Scheduled Power-Off Days can be set to one of four setting values: Off; Every Day; Every Weekday; and Custom. Therefore, the CPU 101 determines in S33 whether the setting item Scheduled Power-Off Days is set to one of the setting values “Every Day,” “Every Weekday,” and “Custom.”

When the CPU 101 determines in S33 that the setting item Scheduled Power-Off Days is set to a setting value other than “Off” (S33: YES), in S34 the CPU 101 obtains the current day and time and in S35 determines whether the day and time point set for the scheduled power-off has arrived based on the obtained current day and time. Here, the day and time point set for the scheduled power-off is determined based on the setting value of the setting item Scheduled Power-Off Days and the setting value of the setting item Scheduled Power-Off Time.

As a specific example, when the setting value of the setting item Scheduled Power-Off Days is “Custom,” the custom schedule is “Every Monday” and the setting value of the setting item Scheduled Power-Off Time is “7:00 AM,” the CPU 101 determines every Monday whether the current time has reached 7:00 AM. As another example, when the custom schedule is “Every Day” and the setting value of the setting item Scheduled Power-Off Time is “0:00 AM,” the CPU 101 determines every day whether the current time has reached 0:00 AM. As another example, when the custom schedule is “Every Weekday” and the setting value of the setting item Scheduled Power-Off Time is “0:00 AM,” the CPU 101 determines every day from Monday through Friday of each week whether the current time has reached 0:00 AM.

While the user can specify a desired setting value for the setting item Scheduled Power-Off Time in the present embodiment, the present disclosure is not limited to this configuration, and the user may not be allowed to specify a desired setting value. In this case, the manufacturer or vendor of the MFP 1 may preset a setting value for the setting item Scheduled Power-Off Time. Alternatively, the administrator of the MFP 1 may preset a setting value according to a method different from one using a settings screen. In the present embodiment, the user can specify a setting value for the setting item Scheduled Power-Off Time in one-minute increments using the Schedule Power-Off Time settings screen 131 illustrated in FIG. 4B, but the present disclosure is not limited to this configuration. For example, the user may be allowed to specify a setting value only in predetermined time increments, such as hourly units, or within broader time ranges, such as morning or afternoon. In such cases, the manufacturer, vendor, or administrator of the MFP 1 may be permitted to freely specify any time including times within the restricted ranges as a setting value.

The determination in S35 as to whether the day and time point set for the scheduled power-off has arrived may be made as follows. When the setting value of the setting item Scheduled Power-Off Days is “Custom,” the custom schedule is “Every Monday” and the setting value of the setting item Scheduled Power-Off Time is “7:00 AM,” the CPU 101 may determine that the scheduled day and time has arrived when the current date is Monday and the current time is 7:00 AM or later. Alternatively, the CPU 101 may be configured to determine that the day and time point set for the scheduled power-off has arrived only when the current day and time falls within a specific time range starting at 7:00 AM on Monday, and to determine that the day and time point set for the scheduled power-off has not arrived when the obtained current day and time is outside that time range. For example, when the upper limit of the specific time range is set to 8:00 AM and the setting value is configured in one-minute increments, the CPU 101 may determine that the day and time point set for the scheduled power-off has arrived when the obtained current day and time is between 7:00 AM and 8:00 AM on Monday, but not at 8:01 AM or later. This upper time limit is not limited to 8:00 AM; it may instead be set to 2:00 PM, 7:00 PM, or any other time on or after 7:00 AM. In addition, even when the obtained current day and time indicates Monday at or after 7:00 AM, the CPU 101 may be configured not to determine that the day and time point set for the scheduled power-off has arrived when the MFP 1 has been powered on after 7:00 AM on Monday.

When the CPU 101 determines in S35 that the current day and time obtained in S34 has reached the day and time point set for the scheduled power-off (S35: YES), in S37 the CPU 101 determines that power-off is to be executed, that is, the MFP 1 is to be powered off, and subsequently ends the power-off execution determination process. However, when the CPU 101 determines that the current day and time has not yet reached the day and time point set for the scheduled power-off (S35: NO), in S36 the CPU 101 determines that power-off is not to be executed, that is, the MFP 1 is not to be powered off, and subsequently ends the power-off execution determination process.

On the other hand, when the CPU 101 determines in S33 that the setting value of the setting item Scheduled Power-Off Days is “Off” (S33: NO), in S36 the CPU 101 determines that power-off is not to be executed, that is, the MFP 1 is not to be powered off, and subsequently ends the power-off execution determination process.

In the power-off execution determination process, the CPU 101 first performs the determination process for the auto power-off function (S30) and then performs the determination process for the scheduled power-off function (S33) after reaching a NO determination in either S30 or S32, but the order of the processes may be reversed. That is, the CPU 101 may first perform the determination process for the scheduled power-off function (S33) and then perform the determination process for the auto power-off function (S30) after reaching a NO determination in either S33 or S35.

Returning to FIG. 7, in S14 the CPU 101 determines whether power-off is to be executed. When the result of the power-off execution determination process of S13 is that power-off is not to be executed (S14: NO), in S15 the CPU 101 determines that the MFP 1 is to be maintained in the deep sleep state, and subsequently ends the power-off state transition determination process. Furthermore, when the CPU 101 determines in S12 that power-off is not possible (S12: NO), in S16 the CPU 101 also determines that the MFP 1 is to be maintained in the deep sleep state, and subsequently ends the power-off state transition determination process. On the other hand, when the result of the process of S13 is that the power-off is to be executed (S14: YES), in S16 the CPU 101 determines that the MFP 1 is to transition to the auto power-off state and in S17 executes a process to configure the scheduled power-on function (scheduled power-on function setting process).

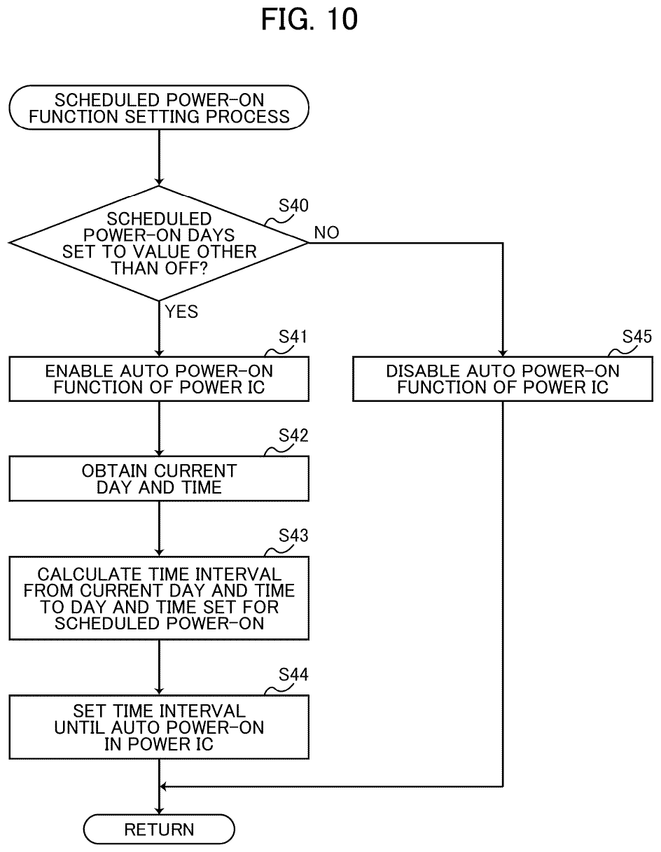

FIG. 10 illustrates steps in the scheduled power-on function setting process. In S40 of FIG. 10, the CPU 101 determines whether the setting item Scheduled Power-On Days is set to a setting value other than “Off.” As described above with reference to FIG. 5, the setting item Scheduled Power-On Days can be set to one of four setting values: Off; Every Day; Every Weekday; and Custom. Therefore, in S40 the CPU 101 determines whether the setting item Scheduled Power-On Days is set to one of the setting values “Every Day,” “Every Weekday,” and “Custom.”When the CPU 101 determines in S40 that the setting item Scheduled Power-On Days is set to a setting value other than “Off” (S40: YES), in S41 the CPU 101 enables the auto power-on function of the power IC 109. In S42 the CPU 101 obtains the current day and time. In S43 the CPU 101 calculates the time interval from the current day and time to the day and time point set for the scheduled power-on, that is, the length of time interval until the next scheduled power-on. Here, the day and time point set for the scheduled power-on is determined based on the setting value of the setting item Scheduled Power-On Days and the setting value of the setting item Scheduled Power-On Time. As a specific example, when the setting value of the setting item Scheduled Power-Off Days is “Every Weekday” and the setting value of the setting item Scheduled Power-Off Time is “8:00 AM,” the CPU 101 calculates the time interval from the current day and time to 8:00 AM on the next weekday. Next, in S44 the CPU 101 sets the time interval until auto power-on, i.e., the time interval calculated in S43, in the power IC 109, and subsequently ends the scheduled power-on function setting process.

Here, a description will be given for the auto power-on function of the power IC 109. The power IC 109 is configured so that the CPU 101 can set a value corresponding to the time interval. The value is an integer, for example. The power IC 109 is configured to decrement the value set by the CPU 101 at predetermined intervals when the auto power-on function is enabled, and is configured to begin supplying the MFP 1 with power from the commercial AC power supply 200, which has not been supplying power prior to this time, when the value reaches “0”. In other words, the power IC 109 is configured to turn on power from the commercial AC power supply 200 to the MFP 1 when the decremented value reaches “0”.

On the other hand, when the CPU 101 determines in S40 that the setting value of the setting item Scheduled Power-On Days is “Off” (S40: NO), in S45 the CPU 101 disables the auto power-on function of the power IC 109, and subsequently ends the scheduled power-on function setting process.

Returning to FIG. 7, after configuring the scheduled power-on function in S17, in S18 the CPU 101 instructs the power IC 109 to turn off the power supply. Subsequently, the CPU 101 ends the power-off state transition determination process.

On the other hand, when the CPU 101 determines in S10 that the power key 102A has been pressed and held (S10: YES), in S19 the CPU 101 determines that the MFP 1 is to transition to the manual power-off state, and subsequently advances to S17. Since the processes in S17 and S18 have been described earlier, a description of these processes will not be repeated here. After completing the processes in S17 and S18, the CPU 101 ends the power-off state transition determination process.

FIG. 11 illustrates steps in a warming-up state transition determination process. Note that FIG. 11 combines processes executed by the CPU 101 and processes executed by the power IC 109. The warming-up state transition determination process is started in response to the MFP 1 transitioning to the power-off state (see FIG. 6) and is repeatedly performed while the MFP 1 is maintained in the power-off state.

In S100 of FIG. 11, the power IC 109 determines whether the power key 102A has been pressed. When the power key 102A has been pressed (S100: YES), in S104 the power IC 109 begins supplying power from the commercial AC power supply 200 to the CPU 101 and memory 103 of the MFP 1. In other words, in S104 the power IC 109 turns on the power from the commercial AC power supply 200 to the CPU 101 and memory 103. After being powered on, in S105 the CPU 101 determines to cause the MFP 1 to transition to the warming-up state and subsequently ends the warming-up state transition determination process.

Once the CPU 101 has determined to cause the MFP 1 to transition to the warming-up state, the CPU 101 instructs the power IC 109 to begin supplying power to the fuser 7. That is, the CPU 101 instructs the power IC 109 to turn on power to the fuser 7. The power IC 109 may also begin supplying power to the fuser 7 automatically in S104. In S104 the power IC 109 may also begin supplying power to other components in the MFP 1. That is, in S104 the power IC 109 may also turn on power to other components in the MFP 1. Alternatively, after determining to cause the MFP 1 to transition to the warming-up state, the CPU 101 may instruct the power IC 109 to begin supplying power to other components in the MFP 1.

On the other hand, when the power IC 109 determines in S100 that the power key 102A has not been pressed (S100: NO), in S101 the power IC 109 determines whether the auto power-on function of the power IC 109 is enabled. When the power IC 109 determines that the auto power-on function is enabled (S101: YES), in S102 the power IC 109 determines whether the time interval set for the scheduled power-on function has elapsed. As described above in the scheduled power-on setting process of FIG. 10, in S41 the CPU 101 enables the auto power-on function of the power IC 109 and in S44 sets the time interval until auto power-on in the power IC 109. Thereafter, the power IC 109, whose auto power-on function has been enabled, decrements an integer value corresponding to the time interval set in S44 at predetermined intervals. Thus, the process of S102 is specifically the power IC 109 determining whether the decremented value has reached “0”.

When the power IC 109 determines in S102 that the time interval set for the scheduled power-on function has elapsed (S102: YES), the power IC 109 advances to S104 described above. However, when the power IC 109 determines in S102 that the time interval set for the scheduled power-on function has not elapsed (S102: NO), the power IC 109 ends the warming-up state transition determination process without turning on the power (without beginning the supply of power) from the commercial AC power supply 200 to the MFP 1. In other words, the MFP 1 is maintained in the power-off state.

On the other hand, when the power IC 109 determines in S101 that the auto power-on function of the power IC 109 is disabled (S101: NO), the power IC 109 also ends the warming-up state transition determination process without turning on the power from the commercial AC power supply 200 to the MFP 1.

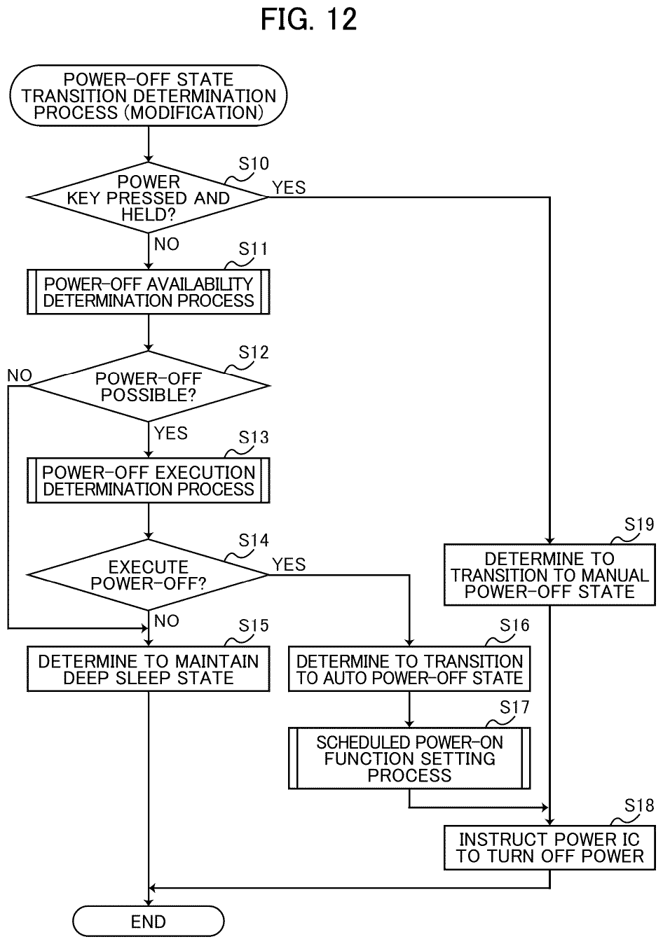

FIG. 12 illustrates a modification of the power-off state transition determination process in FIG. 7. In the power-off state transition determination process of FIG. 7, the CPU 101 executes the scheduled power-on function setting process of S17, even after determining in S19 to cause the MFP 1 to transition to the manual power-off state. Accordingly, when the setting item Scheduled Power-On Days is set to a setting value other than “Off,” the power IC 109 begins supplying power to the MFP 1 in response to the day and time point sets for the scheduled power-on arriving. In contrast, in the modification of the power-off state transition determination process illustrated in FIG. 12, the CPU 101 does not execute the scheduled power-on function setting process of S17 when determining in S19 that the MFP 1 is to transition to the manual power-off state, so that the power IC 109 will not automatically begin supplying power to the MFP 1.

To implement the modification of the power-off state transition determination process in FIG. 12, the CPU 101 executes the process of S18 following S19 and executes the scheduled power-on function setting process of S17 following S16 and before proceeding to S18.

As described above, the MFP 1 according to the above embodiment can store an auto power-off setting in the memory 103 in response to receiving the auto power-off setting via the user interface 102 and can store scheduled power-off settings in the memory 103 in response to receiving the scheduled power-off settings via the user interface 102. While the auto power-off setting is stored in the memory 103 and power to the fuser 7 is off, the CPU 101 can execute an auto power-off process to turn off power to hardware including the CPU 101 and memory 103 when the time period specified by the auto power-off setting has elapsed and other predetermined conditions are met after power to predetermined hardware other than the CPU 101 and memory 103 is turned off. Furthermore, while scheduled power-off settings are stored in the memory 103, power to the fuser 7 is off, and power to the predetermined hardware other than the CPU 101 and memory 103 is off, the CPU 101 can execute a scheduled power-off process to turn off power to the hardware including the CPU 101 and memory 103 when the time point specified by the scheduled power-off settings has passed and other predetermined conditions are met. This enables the MFP 1 to execute either the auto power-off process or the scheduled power-off process for transitioning to a state in which the MFP 1 consumes less power than in the deep sleep state.

### Other Modifications

With the MFP 1 according to the above embodiment, the user configures ecology settings through the user interface 102, including settings related to the scheduled power-off function, the scheduled power-on function, and the auto power-off function. However, the present disclosure is not limited to this method of configuring ecology settings. For example, the user may connect a personal computer (abbreviated as “PC”) to the MFP 1 through the communication interface 106 and use the PC to configure settings. Specifically, the control program 103A may include a program that functions as an embedded web server (abbreviated as “EWS”) when executed by the CPU 101. When the administrator of the MFP 1 starts up a browser on the PC and inputs a predetermined URL for the EWS into the URL input field of the browser, the browser can access the EWS. When accessed by the browser, the CPU 101 can transmit screen data, e.g., web page data, to the browser. Based on this screen data, the browser can display a screen used to configure settings for the MFP 1 on the display of the PC (not illustrated). The MFP 1 can configure the ecology settings by performing a process for modifying settings in response to settings-related operations received through the browser screen.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:
(1) The above embodiment provides an example in which the CPU 101 executes the processes illustrated in FIGS. 3A through 10 and 12, but these processes may be executed by an ASIC or other logic integrated circuit or may be executed by CPUs, ASICs, and/or other logic integrated circuits working together.
(2) In the above embodiment, a time point and day of the week can be specified in the scheduled power-off settings and the scheduled power-on settings, but the date may also be specified. When the date and time point are specified in the scheduled power-off settings, the CPU 101 may determine in S35 whether the current date and time have reached the specified date and the specified time point. When the date is specified in the scheduled power-off settings but not a time point, the CPU 101 may determine in S35 whether the current date and time have reached a specific time point on the specified date. When the date and time point are both specified in the scheduled power-off settings, in S43 the CPU 101 may calculate the time interval from the current date and time to the specified date and specified time point. The user may also be able to set a time interval in the scheduled power-on settings to specify the time interval until the MFP 1 performs auto power-on after transitioning to the power-off state. When a time interval from when the MFP 1 transitions to the power-off state to auto power-on is specified in the scheduled power-on settings, in S44 the CPU 101 can set this specified time interval in the power IC 109.

What is claimed is:

1. An image-forming apparatus comprising:
a printing engine configured to print an image on a printing medium according to an electrophotographic method;
a fuser disposed downstream of the printing engine in a conveying direction of the printing medium, the fuser being configured to fix the image to the printing medium;
a memory; and
a controller configured to perform:
storing, in response to receiving an input specifying an auto power-off time period, the auto power-off time period in the memory; and
storing, in response to receiving an input specifying a power-off schedule including a time point, the power-off schedule in the memory,
wherein the controller is configured to further perform:
an auto power-off process when the auto power-off time period is stored in the memory, the auto power-off process including:
turning off, when a predetermined condition is met and the auto power-off time period has elapsed after the image-forming apparatus transitions to a predetermined state, power to first hardware in the image-forming apparatus, the first hardware being hardware including the controller and the memory, the predetermined state being a state where power to second hardware in the image-forming apparatus is off and power to the fuser is off, the second hardware being predetermined hardware other than the controller and the memory; and
a scheduled power-off process when the power-off schedule is stored in the memory, the scheduled power-off process including:
turning off, when the predetermined condition is met and the time point included in the power-off schedule has passed while the image-forming apparatus is in the predetermined state, the power to the first hardware.

2. The image-forming apparatus according to claim 1,
wherein the controller is configured to cause the image-forming apparatus to transition to the predetermined state by performing:
turning off, in response to a first predetermined time period having elapsed without receiving a print instruction while the power to the fuser is on, the power to the fuser; and
turning off, in response to a second predetermined time period having elapsed without receiving a print instruction after turning off the power to the fuser, the power to the second hardware.

3. The image-forming apparatus according to claim 1,
wherein the power-off schedule further includes a day of week, and
wherein the turning off the power to the first hardware in the scheduled power-off process turns off the power to the first hardware when the predetermined condition is met and the time point included in the power-off schedule has passed on the day of week while the image-forming apparatus is in the predetermined state.

4. The image-forming apparatus according to claim 1,
wherein the controller is configured to further perform:
enabling, in response to receiving an input to enable a specific mode, the specific mode in the image-forming apparatus,
wherein the predetermined condition includes one or more requirements, and
wherein the number of the one or more requirements included in the predetermined condition is greater when the specific mode is disabled than when the specific mode is enabled.

5. The image-forming apparatus according to claim 4,
wherein the image-forming apparatus is configured to consume less power when the specific mode is enabled than when the specific mode is disabled.

6. The image-forming apparatus according to claim 5,
wherein the controller is configured to further perform:
printing an image on a printing medium with the printing engine and the fuser;
when the specific mode is disabled, turning off the power to the fuser in response to a first time period having elapsed without receiving a print instruction after the printing with the printing engine and the fuser has been completed; and
when the specific mode is enabled, turning off the power to the fuser in response to a second time period having elapsed without receiving a print instruction after the printing with the printing engine and the fuser has been completed, the second time period being shorter than the first time period.

7. The image-forming apparatus according to claim 5,
wherein the controller is configured to further perform:
when the specific mode is disabled:
setting a conveying speed of the printing medium to a first speed; and
setting a fixing temperature of the fuser to a first temperature; and
when the specific mode is enabled:
setting the conveying speed of the printing medium to a second speed slower than the first speed; and
setting the fixing temperature of the fuser to a second temperature lower than the first temperature.

8. The image-forming apparatus according to claim 4, further comprising:
a network interface,
wherein the one or more requirements included in the predetermined condition when the specific mode is disabled include, in addition to the one or more requirements included in the predetermined condition when the specific mode is enabled, a requirement that the image-forming apparatus is not connected to a network via the network interface.

9. The image-forming apparatus according to claim 1, further comprising:
a facsimile interface,
wherein the predetermined condition includes a requirement that the image-forming apparatus is not connected to a telephone line via the facsimile interface.

10. The image-forming apparatus according to claim 1,
wherein the controller is configured to further perform:
a stored printing process including:
storing print data based on a print job in the memory; and
executing, in response to an instruction, printing based on the print data stored in the memory, and
wherein the predetermined condition includes a requirement that no print data targeted for the stored printing process is stored in the memory.

11. The image-forming apparatus according to claim 1,
wherein the controller is configured to further perform:
enabling, in response to receiving an input to enable the auto power-off process, the auto power-off process; and
enabling, in response to receive an input to enable the scheduled power-off process, the scheduled power-off process, and
wherein when the auto power-off process is enabled and the auto power-off time period is stored in the memory, the controller performs the auto power-off process, and
wherein when the scheduled power-off process is enabled and the power-off schedule is stored in the memory, the controller performs the scheduled power-off process.

12. The image-forming apparatus according to claim 11,
wherein the controller is configured to place the image-forming apparatus in a state where both the auto power-off process and the scheduled power-off process are enabled.

13. The image-forming apparatus according to claim 11,
wherein the controller is configured to place the image-forming apparatus in a state where either the auto power-off process or the scheduled power-off process is enabled, and
wherein the controller is configured not to place the image-forming apparatus in a state where both the auto power-off process and the scheduled power-off process are enabled.

14. The image-forming apparatus according to claim 1,
wherein the controller is configured to further perform:
storing, in response to receiving an input specifying a power-on schedule including a time point, the power-on schedule in the memory;
when the auto power-off process has been performed while the power-on schedule is stored in the memory, turning on power to the controller in response to the time point included in the power-on schedule passing after performing the turning off the power to the first hardware in the auto power-off process; and
when the scheduled power-off process has been performed while the power-on schedule is stored in the memory, turning on the power to the controller in response to the time point included in the power-on schedule passing after performing the turning off the power to the first hardware in the scheduled power-off process.

15. The image-forming apparatus according to claim 14, further comprising:
a user interface,
wherein the controller is configured to further perform:
turning off, in response to the user interface receiving a specific operation, the power to the controller, and
wherein when the power to the controller has been turned off in response to the user interface receiving the specific operation while the power-on schedule is stored in the memory, the controller does not perform the turning on the power to the controller even when the time point included in the power-on schedule has passed.

16. The image-forming apparatus according to claim 14, further comprising:
a power integrated circuit,
wherein the controller is configured to further perform:
when the power-on schedule is stored in the memory, before performing the auto power-off process:
calculating a time interval from a current time to the time point included in the power-on schedule; and
setting the time interval in the power integrated circuit,
wherein the power integrated circuit is configured to perform:
turning on the power to the controller in response to the time interval set in the power integrated circuit having elapsed after the controller performing the turning off the power to the first hardware in the auto power-off process,
wherein the controller is configured to further perform:
when the power-on schedule is stored in the memory, before performing the scheduled power-off process:
calculating a time interval from a current time to the time point included in the power-on schedule; and
setting the time interval in the power integrated circuit, and
wherein the power integrated circuit is configured to perform:
turning on the power to the controller in response to the time interval set in the power integrated circuit having elapsed after the controller performing the turning off the power to the first hardware in the scheduled power-off process.
